(19) United States
(12) Patent Application Publication
(10) Pub. No.: US 2004/0117317 A1
(43) Pub. Date: Jun. 17, 2004

(54) Apparatus and methods for a united states postal service smart card system

(76) Inventor: Jason S. Feinman, Silver Spring, MD (US)

Correspondence Address: FINNEGAN, HENDERSON, FARABOW, GARRETT & DUNNER, LLP, 1300 I STREET, NW, WASHINGTON, DC, 20005, US

(21) Appl. No.: 10/475,128

(22) PCT Filed: Apr. 18, 2002
(86) PCT No.: PCT/US02/12226

(51) Int. Cl. G06F 17/60

(52) U.S. Cl. 705/65

(57) ABSTRACT

This invention relates to a method of utilizing a smart card which provides access to USPS services. The invention includes a method for distributing USPS services comprises, loading information on to a smart card, and reading, at a USPS system, information on the smart card, such that the information enables service to be provided by the USPS system. The USPS system may be a postal kiosk, an automated postal center, a computer terminal, or a mailbox. The service provided may be identity verification, cash usage, record of transaction, access to facilities, or authority to do business.

### RELATED APPLICATIONS

This application claims the benefit of a provisional application entitled “United States Postal Service Smart Card System,” filed Apr. 18, 2001 and assigned Serial No. 60/284,200. The contents of the above application is relied upon and expressly incorporated herein by reference.

### BACKGROUND

1. Technical Field

This invention relates to apparatus and methods for providing a smart card system. More specifically, this invention relates to providing a USPS smart card system for accessing to USPS services.

2. Related Art

In today's commerce there has been a proliferation in the use of various types of consumer cards, such as credit, debit, identification and authorization cards. For example, an average individual may carry a driver's license, several credit and/or debit cards, an identification card for access to a health club, an identification card to gain access to a place of employment, and an access card to gain entry into a parking garage, among others. Although the use of these cards allow for easy and efficient electronic commerce, the number of such cards quickly becomes cumbersome and many individuals find carrying the large number of cards inconvenient.

The “smart” card, also called IC card, chip card, or memory card, is one of the latest additions to the world of information technology for consolidating and improving card usage. A smart card is similar in size to a credit card, formed of a plastic body with an electronic module, a chip embedded in a special cavity. The chip stores electronic data and programs that are protected by advanced security features. Other types of smart cards include cards with a magnetic stripe or bar code. A smart card may accommodate more than one application while maintaining separate security conditions.

When connected with a reader, a smart card may have the processing power to serve many different applications. As an access-control device, smart cards make personal and business data available only to the appropriate customers. Another application provides customers with the ability to make a purchase or exchange value. Smart cards provide data portability, security and convenience.

Smart cards come in at least two types: contact cards and contactless cards. Contact smart cards include a small gold plate about one-half inch in diameter. When the card is inserted into a smart card reader, it is the gold plate electrical contact with connectors in the reader that transfer data to and from the chip.

Contactless smart cards look like plastic credit cards, except that they have a chip and an antenna embedded inside. These components allow the card to communicate with an antenna/coupler unit in a reader without making physical contact. Contactless cards are the ideal solution when transactions must be processed very quickly, as in mass-transit or toll collection activities. Another type of card is a combination card which is a combination of the contact and contactless card.

The size of a smart card is determined by an international standard, ISO 7810. The ISO 7816 standard also defines the physical characteristics of the plastic, including the temperature range and flexibility, position of the electrical contacts and how the microchip communicates with the outside world. A number of standards have also been defined for specific applications, including digital cell phones, credit card functions (Europay, Mastercard, Visa), and electronic purses (Visacash, Mondex, Proton).

The U.S. Postal Services (USPS), an independent establishment of the executive branch of the U.S. Government, provides many services through a variety of systems. One of these systems is a postal kiosk. A postal kiosk, such as an Automated Postal Center, is described in more detail in International Application “Systems and Methods of an Automated Postal Center,” filed Sep. 8, 2001 with publication number WO 02/21454 A1, which is expressly incorporated herein by reference. In order to authenticate customers, consolidate use of USPS facilities, detect fraud, conduct secure transactions, and protect privacy, the use of a single USPS smart card for enabling USPS transactions is desirable.

### SUMMARY

In accordance with the invention, a method for accessing USPS services through the use of a smart card is provided. The method for distributing USPS services comprises, loading information on to a smart card, and reading, at a USPS system, information on the smart card, such that the information enables service to be provided by the USPS system. The USPS system may be a postal kiosk, an automated postal center, a computer terminal, or a mailbox. The service provided may be identity verification, cash usage, record of transaction, access to facilities, or authority to do business.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 is an illustration of a smart card in which methods and apparatus consistent with the invention may be implemented.

FIGS. 2A and 2B are illustrations of the module in a smart card in which methods and apparatus consistent with the invention may be implemented.

FIG. 3 shows an internal block diagram of a module in which methods and apparatus consistent with the invention may be implemented.

FIG. 4 is an illustration of the information stored in a smart card in which methods and apparatus consistent with the invention may be implemented.

FIG. 5 is a flowchart of an exemplary method for performing methods of using a USPS smart card.

FIG. 6 is a block diagram of types of services that may be accessed with a smart card in which methods and apparatus consistent with the invention may be implemented.

### DETAILED DESCRIPTION

Reference will now be made in detail to exemplary embodiments of the invention, examples of which are illustrated in the accompanying drawings.

This invention relates to smart cards for facilitating transactions at USPS vending machines and kiosks, including access to computer systems at USPS public computer stations. The smart card will permit authentication of the customer and store personal information about the customer which may be downloaded to various computer systems. In addition, the smart cards will provide proof of authority to make transactions.

For the purposes of this specification and appended claims, unless otherwise indicated, all numbers expressing size, proportions, dimensions, quantities, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

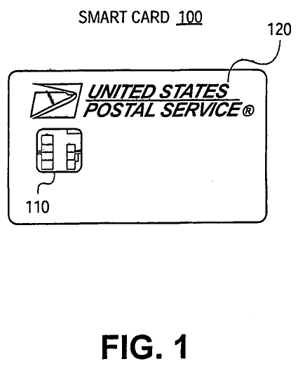

FIG. 1 is an illustration of an exemplary smart card 100 in which methods and system consistent with the invention may be implemented. Smart card 100 includes an electronic module 110. Smart card 100 may have a width of 85.6 mm, a height of 53.98 mm, and a thickness of 0.76 mm. Smart card 100 may be a plastic, such as Polyvinyl Chloride (PVC) or Acrylonitrile Butadiene Styrene (ABS), which is able to deform up to 2 cm on the long side and 1 cm on the short side. Smart card 100 may be printed with images, such as USPS logo 120. In alternate embodiments, smart card 100 may be transparent, may include a scratch off game, or contain advertising.

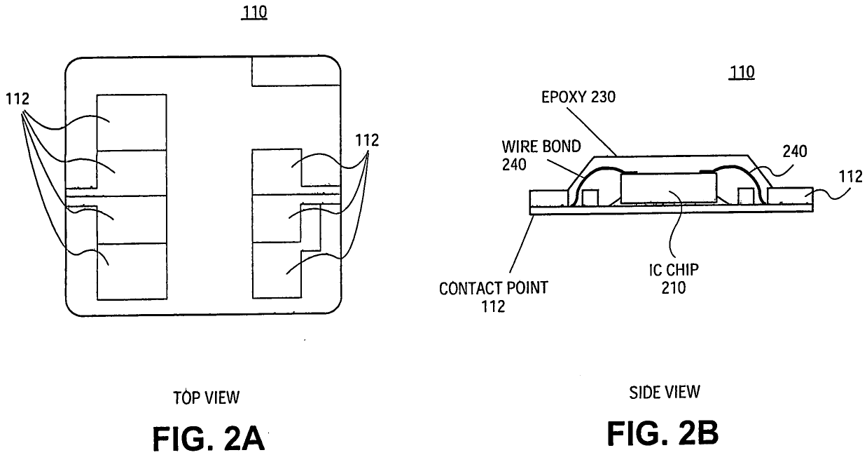

Module 110 may have a minimal contact size of 2 mm by 1.7 mm and include a gold plated surface. Transmission of commands, data, and card status takes place via a direct connection to the physical contact points of module 110. Module 110 is further described in FIGS. 2A and 2B.

Smart card 100 may have forms other than that of a card, such as a coin, a ring, or even a baggage label. Smart card 100 may also be integrated with biometric apparatus to use DNA, fingerprints, retinal eye scans, or voice prints to facilitate authorization by use of a spoken word or the touch of a hand.

FIGS. 2A and 2B are illustrations of an exemplary module 110 in which methods and system consistent with the invention may be implemented. FIG. 2A is a top view of the module, illustrating the contact points 112 for communicating with a smart card reader (not shown). Module 110 is embedded into smart card 100. Prior to embedding, a cavity is formed or milled into a plastic card. Then either a cold or hot glue process bonds the module to the card.

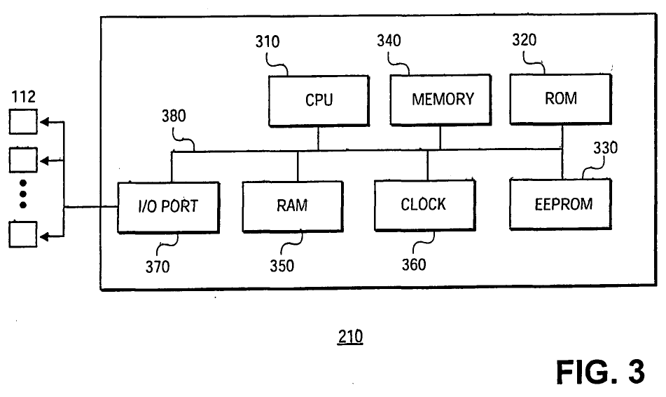

FIG. 2B is an illustration of a side view of module 110. Module 110 includes an integrated circuit (IC) chip 210, epoxy potting material 230, wire bonds 240, and contact points 112. IC chip 210 is further described with FIG. 3. Contact points 112 may be a gold plated pad for interacting with a smart card reader (not shown). Epoxy 230 may be a flexible matrix material which may comprise epoxy resin, thermoset material, thermoplastic material, or combinations thereof. Wire bonds 240 connects microprocessor 210 to contact points 112 for communication with a smart card reader<not shown).

FIG. 3 is an internal block diagram of an exemplary IC chip 210 in which methods and system consistent with the invention may be implemented. IC chip 210 includes several components all interconnected via a system bus 380. Bus 380 may be, for example, a bi-directional system bus that connects the components of IC chip 210. For example, bus 380 may contain thirty two bit address lines for addressing a memory 340 and thirty-two bit data lines for transferring data among the components. Alternatively, multiplex data/address lines may be used instead of separate data and address lines. IC chip 210 may communicate with smart card reader via I/O port 370. IC chip 210 contains a central processing unit (CPU) 310 connected to a memory 340. CPU 310 may be a microprocessor, such as a RISC processor. Memory 340 may include non-volatile memory for data storage. ROM 320 may include memory for the card operating system. RAM 350 may be used for the operating system computation. EEPROM 330 may be used for externally accessible, non-volatile memory. Clock 360 may have a clock rate between 3.5 and 8 MHz.

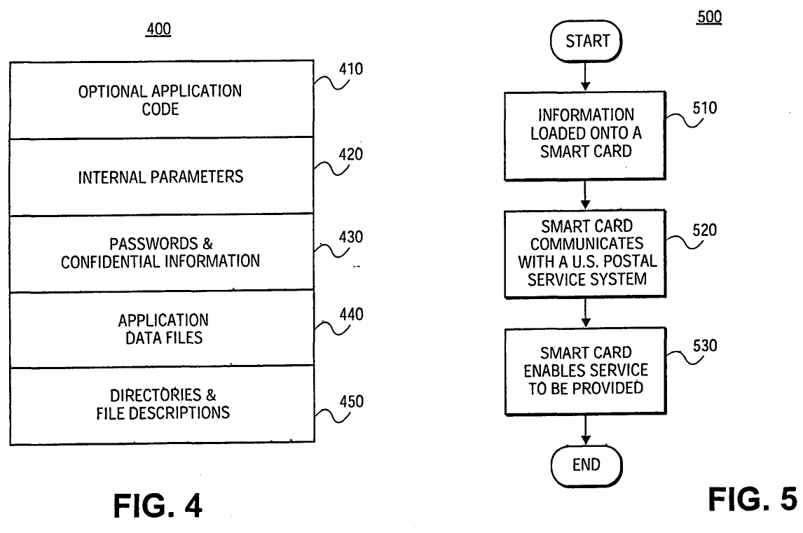

FIG. 4 is an illustration data 400 stored in ROM 320 and/or EEPROM 330 smart card 100 in which methods and apparatus consistent with the invention may be implemented. Data 400 may include optional application code 410, internal parameters 420, passwords and confidential information 430, application data fields 440, and directories and file descriptions 450. Optional application code 410 allows for the downloading of computer instructions in the form of application code for a variety of services. Optional applications may be developed with JavaCard technology and Multos by Mondex. Internal parameters 420 may be used by IC chip 210 to control the internal parameters of the card. Passwords and confidential information 430 include the storage of customer specific passwords and confidential information, such as bank account numbers, credit card number, social security numbers, or any other customer specific confidential information. Application data fields 440 allow for the storage of application data, such as the amount of cash left on smart card 100. File descriptors 450 may be used to help in the access of local information.

FIG. 5 is a flowchart of an exemplary method for performing methods of using a USPS smart card. Information is loaded onto smart card 100 (step 510). Information may be loaded either by a smart card programming machine or manually at a USPS facility. Smart card 100 for particular applications and a particular monetary value may be sold at a USPS counter by accepting cash from the customer. The customer may then use smart card 100 for the purchase of postal services, without the use of cash.

Next, smart card 100 communicates with a USPS system (step 520). The USPS system may be a vending machine, a kiosk, an Automated Postal Center, or any other type of USPS system that helps to facilitate a service. Smart card 100 communicates with the USPS system by being inserted into a smart card reader associated with the machine.

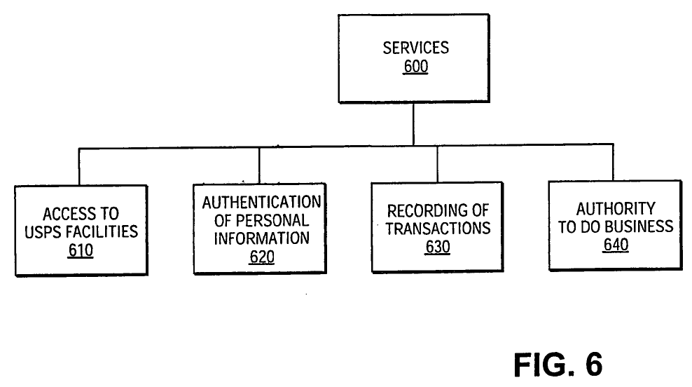

Smart card 100 enables a USPS service to be provided (step 530). Examples of the service provided are listed in FIG. 6. Smart card 100 allows for multiple services to be provided. Services include use of smart card 100 for cash as an electronic purse holding electronic money, storing personal information, obtaining internet access, purchasing transportation, recording healthcare information, banking and using as a loyalty card, such as for a postal service loyalty or identification purchase program. Once a service is provided, smart card 100 may be reused.

In another embodiment, smart card 100 may include providing customers access to electronic mailboxes and physical mailboxes. A customer may have an electronic mailbox. Smart card 100 may provide authentication of the customer's identity at a computer terminal, thus allowing the customer access to the customer's electronic mailbox and/or access to other secure areas, such as a file directory or secure web site. Other postal services and products such as a physical mailbox may also be accessed by a customer's smart card, smart card 100 acting as an electronic key to provide access to the physical mailbox.

In another embodiment, Federal benefits may be distributed to customers via smart card 100. The recipient of benefits would physically access a specific machine with smart card 100 and either recharge with the card electronic monetary value or receive cash.

FIG. 6 is a block diagram of types of services that may be accessed with a smart card in which methods and apparatus consistent with the invention may be implemented. Services 600 include access to USPS facilities 610, authentication of personal information 620, recording of transactions 630 and authority to do business 640. Access to USPS facilities 610 encompasses using smart card 100 to access postal kiosks and automated postal centers.

Authentication of personal information 620 encompasses using smart card 100 to authenticate the customer. This authentication may be provided using a security model convenient for the average person to use. One security model will use a PIN number, while another model will eliminate the PIN number requirement and substitute an encrypted mathematical representation of a biometric feature from the owner of the card. The card may include information about the owner such as, the owner's address and phone number.

Recording of transactions 630 encompasses using smart card 100 to record all transactions attempted by a customer. This may include recording all times and places that smart card 100 is used.

Authority to do business 640 encompasses using smart card 100 to provide information to parties with whom a customer conducts business. The customer may keep personal and identifying information on smart card 100. For example, if the customer wanted to conduct secure transactions with a provider (e.g. store, bank, etc.) over the Internet smart card 100 will include information or verification routines that will notify the provider that the card user is indeed the customer. Also, smart card 100 may contain authorization information informing the provider that the customer does indeed have the authorization to make the transaction. For example, if a customer were making a transaction on behalf of the customer's company, smart card 100 may contain information to inform the provider that the customer may only bind the customer's company up to a certain amount of money. The customer may select the information to be stored on smart card 100, or the USPS may dictate the types of information to be stored.

In one embodiment, personal information may be saved on smart card 100 itself rather than entered into a data base. Information such as, but not limited to, customers name, address, phone number, customer number, birth date, hair color, eye color, Social Security number, blood type, medical information, authorization information and an electronic identification number may be stored electronically on the card. The smart card may provide desired information to sites accessed by the customer, but need not provide all sites with the same information. In one way of using smart card 100, sites accessed by the customer will keep no record of personal information, but receive it from smart card 100 each time the customer accesses a site. In another variation, sites may store personal information (but not information such as name, address, social security number which may be linked to a specific person) linked to an electronic identification system so that the site operators will recognize when the same customer is accessing a site, therefore allowing customer needs and preferences to be addressed, but not providing site operators with access to identity information.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for distributing USPS services comprising:
loading information on to a smart card;
reading, at a USPS system, information on the smart card;
providing sever by the USPS system in accordance with the information read.

2. The method of claim 1, wherein the smart card contains a biometric security device.

3. The method of claim 1, wherein the information is verification authentication information.

4. The method of claim 1, wherein the information is personal information.

5. The method of claim 1, wherein the information is a monetary value.

6. The method of claim 1, wherein the USPS system is one of a postal kiosk, an automated postal center, a computer terminal, or a mailbox.

7. The method of claim 1, wherein the service to be provided is one of identity verification, cash usage, record of transaction, access to facilities, or authority to do business.
